(19) United States
(12) Patent Application Publication
(10) Pub. No.: US 2024/0394545 A1
(43) Pub. Date: Nov. 28, 2024

(54) Universal Self-Adaptive Prompting

(71) Applicant: Google LLC, Mountain View, CA (US)

(72) Inventors: Julian Martin Eisenschlos, Zürich (CH); Xingchen Wan, Oxford (GB); Hootan Nakhost, Waterloo (CA); Sercan Omer Arik, San Francisco, CA (US); Ruoxi Sun, Santa Clara, CA (US); Hanjun Dai, San Jose, CA (US)

(21) Appl. No.: 18/377,368

(22) Filed: Oct. 6, 2023

Related U.S. Application Data
(60) Provisional application No. 63/468,394, filed on May 23, 2023.

(51) Int. Cl. G06N 3/088; G06N 3/0455

(52) U.S. Cl. CPC G06N 3/088; G06N 3/0455

(57) ABSTRACT

Aspects of the disclosure are directed to methods, systems, and computer readable media for universal self-adaptive prompting (USP), which includes an automatic prompt design approach specifically tailored for zero-shot learning, though still compatible with few-shot learning. To achieve universal prompting, USP categorizes a natural language processing (NLP) task into one of a plurality of possible task types and then uses a corresponding selector to select the most suitable queries and zero-shot model-generated responses as pseudo-demonstrations, thereby generalizing in-context learning to the zero-shot setup in a fully automated manner.

### CROSS-REFERENCE TO RELATED APPLICATIONS

The present application claims the benefit of the filing date of U.S. Provisional Patent Application No. 63/468,394, filed May 23, 2023, the disclosure of which is hereby incorporated herein by reference.

### BACKGROUND

A hallmark of large language models (LLMs) is their impressive general zero-shot and few-shot abilities, often elicited through prompt-based and/or in-context learning. However, while highly coveted and being the most general, zero-shot performances in LLMs are still typically weaker due to the lack of guidance and the difficulty of applying existing automatic prompt design frameworks in general tasks when ground-truth labels are unavailable.

### BRIEF SUMMARY

Aspects of the disclosure are directed to methods, systems, and computer readable media for universal self-adaptive prompting (USP), which includes an automatic prompt design approach specifically tailored for zero-shot learning, though still compatible with few-shot learning. Requiring only a small amount of unlabeled data and an inference only LLM, USP can be highly versatile. To achieve universal prompting, USP categorizes a natural language processing (NLP) task into one of a plurality of possible task types and then uses a corresponding selector to select the most suitable queries and zero-shot model-generated responses as pseudo-demonstrations, thereby generalizing in-context learning to the zero-shot setup in a fully automated manner. USP demonstrates performances that are considerably stronger than previous zero-shot and few-shot baselines across more than 20 natural language understanding (NLU) and natural language generation (NLG) tasks. As such, USP can improve performance with reduced computational complexity and memory usage.

An aspect of the disclosure provides for a method for universal self-adaptive prompting, including: receiving, by one or more processors, a query describing a machine learning task; generating, by the one or more processors, a plurality of candidate responses to the query using a machine learning model; categorizing, by the one or more processors, the machine learning task into one of a plurality of task types; selecting, by the one or more processors, one or more candidate responses of the plurality of candidate responses to be pseudo-demonstrations based on the task type for the machine learning task; prepending, by the one or more processors, the pseudo-demonstrations to the query; and generating, by the one or more processors, a response to the query using the machine learning model based on the query prepended with the pseudo-demonstrations.

In an example, the plurality of task types includes classification, short form generation, and long form generation. In another example, selecting the one or more candidate responses is based on an entropy metric for classification task types, a consistency metric for short form generation task types, and an overlap metric for long form generation task types.

In yet another example, the query received includes an unlabeled dataset. In yet another example, categorizing the machine learning task is based on an amount of possible responses and an amount of correct responses. In yet another example, the response to the query is generated based on a maximum likelihood estimated output.

In yet another example, generating the response to the query is repeated a plurality of times using the machine learning model based on the query prepended with the pseudo-demonstrations. In yet another example, the method further includes generating a final response to the query based on a majority voting output. In yet another example, the machine learning model is a large language model.

Another aspect of the disclosure provides for a system including: one or more processors; and one or more storage devices coupled to the one or more processors and storing instructions that, when executed by the one or more processors, cause the one or more processors to perform operations for universal self-adaptive prompting, the operations including: receiving a query describing a machine learning task; generating a plurality of candidate responses to the query using a machine learning model; categorizing the machine learning task into one of a plurality of task types; selecting one or more candidate responses of the plurality of candidate responses to be pseudo-demonstrations based on the task type for the machine learning task; prepending the pseudo-demonstrations to the query; and generating a response to the query using the machine learning model based on the query prepended with the pseudo-demonstrations.

In an example, the plurality of task types includes classification, short form generation, and long form generation. In another example, selecting the one or more candidate responses is based on an entropy metric for classification task types, a consistency metric for short form generation task types, and an overlap metric for long form generation task types.

In yet another example, the query received includes an unlabeled dataset. In yet another example, categorizing the machine learning task is based on an amount of possible responses and an amount of correct responses. In yet another example, the response to the query is generated based on a maximum likelihood estimated output.

In yet another example, generating the response to the query is repeated a plurality of times using the machine learning model based on the query prepended with the pseudo-demonstrations. In yet another example, the operations further include generating a final response to the query based on a majority voting output.

Yet another aspect of the disclosure provides for a non-transitory computer readable medium for storing instructions that, when executed by one or more processors, cause the one or more processors to perform operations for universal self-adaptive prompting, the operations including: receiving a query describing a machine learning task; generating a plurality of candidate responses to the query using a machine learning model; categorizing the machine learning task into one of a plurality of task types; selecting one or more candidate responses of the plurality of candidate responses to be pseudo-demonstrations based on the task type for the machine learning task; prepending the pseudo-demonstrations to the query; and generating a response to the query using the machine learning model based on the query prepended with the pseudo-demonstrations.

In an example, the plurality of task types includes classification, short form generation, and long form generation. In another example, selecting the one or more candidate responses is based on an entropy metric for classification task types, a consistency metric for short form generation task types, and an overlap metric for long form generation task types.

### BRIEF DESCRIPTION OF THE DRAWINGS

FIG. 1 depicts a block diagram of an example universal self-adaptive prompting (USP) system according to aspects of the disclosure.

FIG. 2 depicts a block diagram of an example USP system illustrating how a machine learning model outputs a response for a query according to aspects of the disclosure.

FIG. 3 depicts a block diagram of an example environment for implementing a USP system according to aspects of the disclosure.

FIG. 4 depicts a block diagram illustrating one or more machine learning model architectures according to aspects of the disclosure.

FIG. 5 depicts a flow diagram of an example process for universal self-adaptive prompting according to aspects of the disclosure.

FIG. 6 depicts a table comparing accuracy on classification tasks using pathway language models according to aspects of the disclosure.

FIG. 7 depicts a table comparing performance on short form generation tasks using pathway language models according to aspects of the disclosure.

FIG. 8 depicts a table comparing performance on long form generation tasks using pathway language models according to aspects of the disclosure.

### DETAILED DESCRIPTION

The technology relates generally to universal self-adaptive prompting (USP), including a universal prompt design framework for zero-shot or few-shot in-context learning across various tasks. USP is a general automatic prompting framework that specifically generalizes in-context learning to zero-shot or few-shot settings via pseudo-demonstrations constructed from unlabeled queries and model-generated outputs. USP can utilize black-box, inference-only LLMs. The use of pseudo-demonstrations allows for USP to operate in a zero-shot setup where only unlabeled queries are used. This can make USP extremely versatile, as unlabeled data is typically readily available, such as via continuous, on-the-fly collections of user queries. Unlike alternative frameworks that often requiring task knowledge beforehand, e.g., class names, USP can require only the task type information, e.g., natural language understanding (NLU) or generation (NLG), while remaining capable of using additional information like class names if the additional information is available. This can enable USP to work in arbitrary, potentially novel tasks at test time and/or tasks that simply cannot be cast as classification problems, e.g., open-domain question answering and generative tasks. USP can utilize various criteria capable of selecting high-quality pseudo-demonstrations in the absence of any ground-truth labels. USP can empirically realize large performance gain over more than 20 NLU and NLG tasks in PaLM-62B and PaLM-540B models. Therefore, USP can improve performance as well as reduce computational complexity and memory usage.

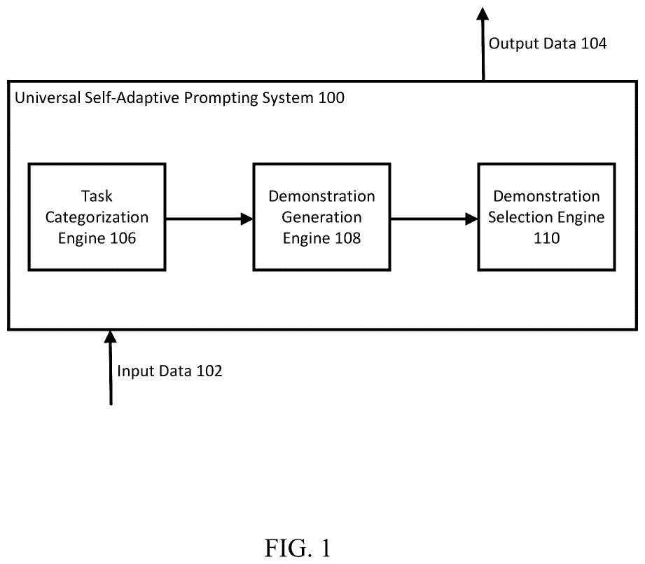

FIG. 1 depicts a block diagram of an example universal self-adaptive prompting (USP) system 100 for generating predictions. The USP system 10 can be implemented on one or more computing devices in one or more locations.

The USP system 100 can be configured to receive input data 102 for use in generating one or more predictions. For example, the USP system 100 can receive the input data 102 as part of a call to an application programming interface (API) exposing the USP system 100 to one or more computing devices. The input data 102 can also be provided to the USP system 100 through a storage medium, such as remote storage connected to the one or more computing devices over a network. The input data 102 can further be provided as input through a user interface on a client computing device coupled to the USP system 100.

The input data 102 can include inference data for a machine learning model, such as an LLM, to respond to a query. The inference data can include one or more queries associated with any machine learning task, such as natural language processing tasks, short form generation tasks, and/or long form generation tasks. Example natural language processing tasks can include classification, reading comprehension, cloze completion, and/or natural language inference. Example short form generation tasks can include open domain question-answer and/or word prediction. Example long form generation tasks can include summarization and/or chain-of-thought prompting.

From the input data 102, the USP system 100 can be configured to output one or more results for responding to a query, generated as output data 104. The output data 104 can include a prediction as an answer to a query. The output data 102 can further include model-generated demonstrations to be used by the machine learning model in processing queries. As an example, the USP system 100 can be configured to send the output data 104 for display on a client or user display. As another example, the USP system 100 can be configured to provide the output data 104 as a set of computer-readable instructions, such as one or more computer programs. The computer programs can be written in any type of programming language, and according to any programming paradigm, e.g., declarative, procedural, assembly, object-oriented, data-oriented, functional, or imperative. The computer programs can be written to perform one or more different functions and to operate within a computing environment, e.g., on a physical device, virtual machine, or across multiple devices. The computer programs can also implement functionality described herein, for example, as performed by a system, engine, module, or model. The USP system 100 can further be configured to forward the output data 104 to one or more other devices configured for translating the output data into an executable program written in a computer programming language. The USP system 100 can also be configured to send the output data 104 to a storage device for storage and later retrieval.

The USP system 100 can include a task categorization engine 106, a demonstration generation engine 108, and a demonstration selection engine 110. The task categorization engine 106, the demonstration generation engine 108, and the demonstration selection engine 110 can be implemented as one or more computer programs, specially configured electronic circuitry, or any combination thereof.

The task categorization engine 108 can be configured to categorize one or more queries of the input data 102 as one of a plurality of possible task types. The task categorization engine 108 can categorize the queries based on the number of possible responses, the number of correct responses, and/or whether logits are implemented. For example, the task categorization engine 108 can categorize a query as one of classification, short form generation, or long form generation based on threshold amounts of possible responses, threshold amounts of correct responses, and/or whether logits are utilized. For instance, an amount of possible responses below a threshold, an amount of correct responses below another threshold, and logits being implemented can be categorized as classification. As another instance, an amount of possible responses above a threshold, an amount of correct responses below another threshold, and logits not being implemented can be categorized as short form generation. As yet another instance, an amount of possible responses above a threshold, an amount of correct responses above another threshold, and logits not being implemented can be categorized as long form generation.

The demonstration generation engine 108 can be configured to generate pseudo-demonstrations for responding to the one or more queries. The demonstration generation engine 108 can generate pseudo-demonstrations using a machine learning model, such as an LLM, with a zero-shot setup where the queries are unlabeled. The demonstration generation engine 108 can further generate pseudo-demonstrations using the machine learning model with a few-shot setup where some queries of the queries are prelabeled with demonstrations.

The demonstration selection engine 110 can be configured to select a generated pseudo-demonstration based on how the one or more queries were categorized. The demonstration selection engine 110 can be configured to select a pseudo-demonstration based on metrics, such as logit, consistency, and/or overlap corresponding to how the one or more queries were categorized. For example, the demonstration selection engine 110 can select a different pseudo-demonstration based on whether the one or more queries were categorized as classification, short form generation, or long form generation. The demonstration selection engine 110 can prepend the selected pseudo-demonstration with the one or more queries for inputting to the machine learning model to output one or more responses, such as predictions, to the one or more queries.

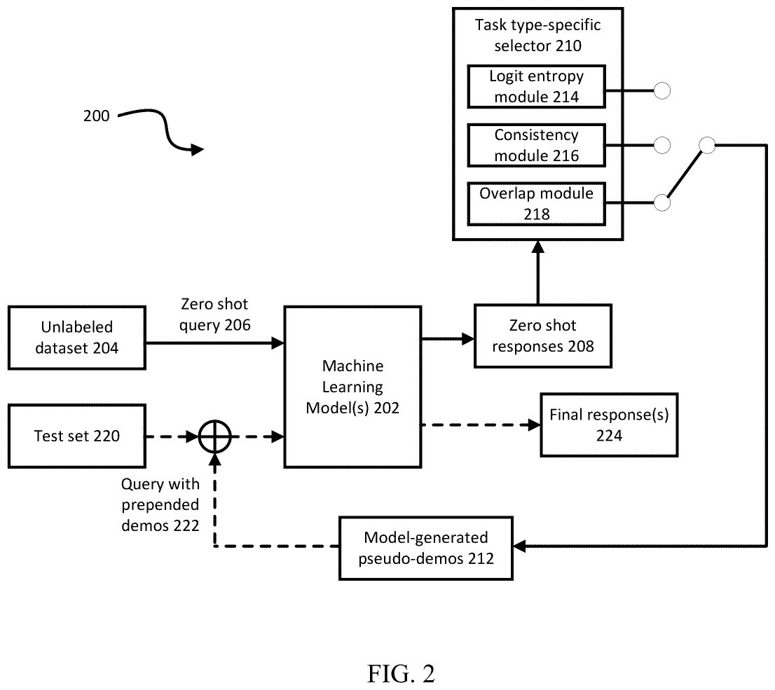

FIG. 2 depicts a block diagram of an example USP system 200 illustrating how a machine learning model outputs a response for a query. The USP system 200 can correspond to the USP system 100 as depicted in FIG. 1. The USP system 200 can adopt a multi-stage approach. In a first stage, depicted with solid lines, the USP system 200 can prompt one or more machine learning models 202 with an unlabeled dataset 204 in a zero-shot manner 206 to generate a collection of candidate responses 208. Alternatively, or additionally, the USP system 200 can prompt the machine learning models 202 with a partially labeled dataset in a one-shot or few-shot manner to generate the collection of candidate responses 208. The machine learning models 202 can be LLMs as an example. The USP system 200 can select via a task type-specific selector 210 one or more model-generated pseudo-demonstrations 212 from the collection of candidate responses 208. The selection can be based on logit entropy 214, consistency 216, and/or overlap 218, as examples. In a second stage, depicted with dashed lines, the USP system 200 can prepend the pseudo-demonstrations 212 to test queries 220 in a one-shot or few-shot manner 222 and prompt the machine learning models 202 again to obtain a final response 224. For example, the USP system 200 can operate as follows:

```
  Input: Test set T = {x⁽ⁱ⁾}ᵢ₌₁^{N}, LLM, unlabeled dataset for demo generation D =
{d^{(j)}}ⱼ₌₁^{N}^{ᵤ}, pool of generated responses P ← Ø, task type t ∈ {CLS, SFG, LFG}. The unlabeled
dataset D can be the same as or a subset of T or a different but related set of unlabeled queries.
  Output: Predictions {ŷ⁽ⁱ⁾}ᵢ₌₁^{N}.
  For j ∈ [1, Nᵤ] do:
  [Stage 1] Query the LLM with d^{(j)} under the zero-shot setup to obtain a prediction \hat{z}^{(j)}
(if t = CLS) or query m times with a non-zero temperature to obtain m predictions {\hat{z}ₖ^{(j)}}ₖ₌₁^{m}
(if t ≠ CLS).
  Add eligible candidate pseudo-demos {pⱼ}ⱼ₌₁^{N}^{ᵤ} (from concatenating d^{(j)} and
\hat{z}^{(j)}) to P.
  End For.
  Build the pseudo-demo set S = {s₁, ... , s_{K}} (with |S| = K) from P with one of the
selectors depending on t.
  For i ∈ [1, N] do:
  [Stage 2] Concatenate the S to x⁽ⁱ⁾ and query again to obtain the final LLM prediction
ŷ⁽ⁱ⁾.
  End For.
```

The task-specific pseudo-demonstration selector 210 can select a query-response pair from the zero-shot responses 208. For example, the pseudo-demonstration selector 210 can select a suitable query-response pair based on a categorization of the machine learning task, such as a query-response pair more likely to be a true label for the machine learning task. The task-specific selector 210 allows for versatility in the applicability of tasks to be processed by the machine learning models 202.

The USP system 200 can receive an unlabeled dataset 204 whose purpose is to generate the pseudo-demonstrations 212, even if a full test set is unknown beforehand or only a small number of unlabeled queries are available. For example, the USP system 200 can be capable of generating higher quality pseudo-demonstrations with a small number, e.g., 64, unlabeled samples per dataset. This allows the USP system 200 to be more sample efficient, due to the smaller number of unlabeled samples required, and more computationally efficient, as the process only iterates through the unlabeled dataset. As such, the USP system 200 can have reduced computational complexity and reduced memory usage while still improving processing performance.

The USP system 200 can utilize the machine learning models 202 to decode once in its second stage with an argmax sampling, e.g., temperature is 0, and can implement a maximum likelihood estimated (MLE) output as the final response 224. Implementing MLE for determining the final response 224 can further reduce computational cost compared to implementing a majority vote over multiple decodings. Alternatively, or additionally, the USP system 200 can utilize the machine learning models 202 to decode multiple times and implement a majority (or threshold plurality) vote as the final response 224. Implementing majority vote can improve performance but increases computational cost.

The task type selector 210 can build a pool of candidate pseudo-demonstrations P, whose elements p^{(j)} are built from concatenated dataset queries {d^{(j)}}ⱼ₌₁^{N}^{ᵤ} and their zero-shot machine learning model predictions {\hat{z}ₖ^{(j)}}ₖ₌₁^{m}. The task type selector 210 can further select S, as subset of K pseudo-demonstrations from P to be prepended to the test queries. The task type selector 210 can utilize a function F: P→R to score each candidate. For example, the task type selector 210 can select the first pseudo-demonstration in S by finding the maximizer of F(·) in P. For each of the subsequent pseudo-demonstrations k∈{2, . . . , K}, the task type selector 210 can iteratively find the maximizer of F(·) with a diversity-promoting term to penalize candidates that are too similar to any of the pseudo-demonstrations already selected. The task type selector 210 can add these candidates to S. For example:

$${s}_{k} = arg {max}_{p ∈ P ∖ {S}_{1 : k - 1}} ( F ( p ) - λ {max}_{{k}^{′} = 1}^{k - 1} ( {S}_{c} ( ϕ ( p ) , ϕ ( {s}_{{k}^{′}} ) ) ) )$$

where λ is a tradeoff parameter and, as an example, can be set to 0.2, S_{c}(·, ·) can denote the cosine similarity, and ϕ(·) can be the sentence-level embedding given by an auxiliary model.

The function F(·) can encode that pseudo-demonstrations should be prepended to test queries for in-context learning. The task specific selector 210 can categorize a possible task into a plurality of types depending on the number of possible responses and the number of correct responses. The categorization can determine which scoring function F(·) the task specific selector 210 utilizes to select candidate pseudo-demonstrations. Example categorizations can be classification, short-form generation, and/or long-form generation.

Classification can refer to a categorization of queries that feature the selection of a correct answer from a few possible options. For instance, the number of possible responses can be below a threshold and the number of correct responses can also be below a threshold. The task can be cast as a classification problem over a set of possible classes C: \hat{z}^{(j)}=argmax_{c∈C}P(c|d^{(j)}). Since logits are available, prediction confidence can be estimated without a self-consistency based confidence metric. Alternatively, or additionally, prediction confidence can be estimated with a self-consistency based confidence metric, such as if the model is poorly calibrated due to logits being unreliable or self-consistency is otherwise valuable for the classification like when chain-of-thought prompting is used and generating diverse reasoning paths is helpful. For example, without self-consistency, for p^{(j)}=concat(d^{(j)}, \hat{z}^{(j)})∈P, the negative entropy of the distribution over C is used as F:

$${F}_{CLS} ( {d}^{( j )} ) : = {\sum }_{c ∈ C} \tilde{P} ( {d}^{( j )} ) log log \tilde{P} ( {d}^{( j )} )$$

where \acute{P}(d^{(j)}) can be the normalized probability, e.g., Σ_{c∈C}\acute{P}(d^{(j)})=1. Further, to build S, K/|C| pseudo-demonstrations are generated per class c∈C from a subset P_{c}⊂P for each c. For example:

$${P}_{c} = \{ {p}^{( j )} ∈ P if {\hat{z}}^{( j )} = c ∀ j ∈ \{ 1 , … , {N}_{u} \} \} .$$

This is to account for some machine learning models being more confident in some classes, so simply choosing the most confident predictions overall as pseudo-demonstrations may lead to poor label space coverage and bias towards these classes. This can be mitigated to ensure that the selected pseudo-demonstrations K feature each class approximately fairly.

For other example scenarios where K<|C| or mod(K, |C|)≠0, then

$$⌈ \frac{K}{\vert C \vert} ⌉$$

pseudo-demonstrations can be generated per class and each test query x⁽ⁱ⁾∈T can be prepended with K randomly sampled pseudo-demonstrations to ensure fairness in expectation over T. For yet other example scenarios where some classes may not be predicted in D, such as an over-confident model that may never predict a “not sure” option in a natural language inference task. In such an example scenario, the set P_{c} can be empty for these unpredicted classes. To still generate plausible pseudo-demonstrations for them, for an unpredicted class cᵤ, top queries in D are selected with higher model-assigned probability in cᵤ. For example:

$$Top \frac{K}{{\vert C \vert}_{{d ( j )}_{∈ D}}} ( P ( {d}^{( j )} ) )$$

noting that the indexing can be over the unlabeled dataset D. These queries can then be concatenated with class label cᵤ to form the pseudo-demonstrations for these unpredicted classes.

Short form generation can refer to a categorization of queries that feature the selection of one to a few correct, short responses out of many possible responses. For instance, the number of possible responses can be above a threshold and the number of correct responses can be below a threshold. An example short form generation categorization can be a question answering task where the possible responses span over an entire vocabulary set V. Short form generation categorization can also be used for classification tasks if implementing text-to-text formulation, have no access or prefer not to use logits, or when self-consistency multiple decoding is preferable. Short form generation can include access to model outputs \hat{z}^{(j)} but not logit distribution, such as arithmetic reasoning, and can implement normalized entropy to gauge model confidence. In non-chain-of-thought example tasks, the rational generation step can be skipped, and answers can be directly prompted. For example, for each d^{(j)}∈D, the machine learning model is queried for m repetitions, under temperature sampling, to obtain m predictions {\hat{z}ₗ^{(j)}}ₗ₌₁^{m}. While only majority predictions, or a threshold level plurality of predictions, of each query may be added to P:={Maj({\hat{z}ₗ^{(j)}}ₗ₌₁^{m})}ⱼ₌₁^{N}^{ᵤ}, all m predictions may be used to score model confidence for each p^{(j)}∈P. For example:

$${F}_{SFG} ( {\{ {\hat{z}}_{l}^{( j )} \}}_{l = 1}^{m} ) : = - \frac{{\sum }_{α = 1}^{μ} \tilde{P} ( {\hat{z}}_{α}^{( j )} ) log log \tilde{P} ( {\hat{z}}_{α}^{( j )} )}{log log m}$$

where μ≤m can be a number of unique answers and \tilde{P}(\hat{z}_{α}^{(j)}) can be the empirical frequency of a unique answer \hat{z}_{α}^{(j)} in m predictions for d^{(j)}.

Long form generation can refer to a categorization of queries that feature longer responses and many plausible responses. For instance, the number of possible responses can be above a threshold and the number of correct responses can be above a threshold. Example long form generation categorization can be summarization and/or translation.

To measure confidence in long form generation, each d^{(j)}∈D can be queried for m repetitions {\hat{z}ₗ^{(j)}}ₗ₌₁^{m} with temperature sampling. An average pairwise Rouge score is computed between all pairs of the m responses. For example:

$${F}_{LFG} ( {\{ {\hat{z}}_{l}^{( j )} \}}_{l = 1}^{m} ) : = \frac{2 {\sum }_{l = 1 , {l}^{′} = 1 , l ′ \neq l}^{m} Rouge ( {\hat{z}}_{l}^{( j )} , {\hat{z}}_{{l}^{′}}^{( j )} )}{m ( m - 1 )} .$$

Alternatively or additionally, other overlap metrics, such as pairwise BLEU or sentence level embedding cosine similarity from another auxiliary model may be used instead to evaluate how close two texts are to one another.

The function F_{LFG} can be used to rank confidence of the queries in D and determine which queries to be used in S only. For the response part of the pseudo-demonstrations, the machine learning model can be decoded again with argmax sampling, e.g., temperature is 0, to obtain MLE predictions on the selected queries. These predictions can then be concatenated with queries to build S. Outlier filtering can further be implemented to remove queries with a score greater than an outlier threshold, such as upper quartile+1.5× interquartile range (IQR). This can remove model generations of high confident text completions instead of actually completing the instructed task, which tend to have high average pairwise Rouge scores.

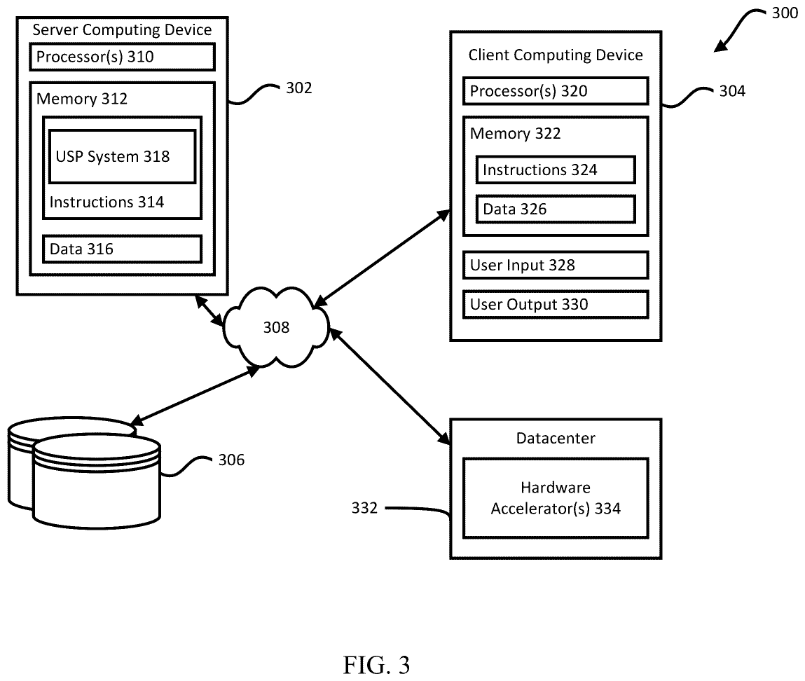

FIG. 3 depicts a block diagram of an example environment 300 for implementing a universal self-adaptive prompting system 318. The USP system 318 can be implemented on one or more devices having one or more processors in one or more locations, such as in server computing device 302. Client computing device 304 and the server computing device 302 can be communicatively coupled to one or more storage devices 306 over a network 308. The storage devices 306 can be a combination of volatile and non-volatile memory and can be at the same or different physical locations than the computing devices 302, 304. For example, the storage devices 306 can include any type of non-transitory computer readable medium capable of storing information, such as a hard-drive, solid state drive, tape drive, optical storage, memory card, ROM, RAM, DVD, CD-ROM, write-capable, and read-only memories.

The server computing device 302 can include one or more processors 310 and memory 312. The memory 312 can store information accessible by the processors 310, including instructions 314 that can be executed by the processors 310. The memory 312 can also include data 316 that can be retrieved, manipulated, or stored by the processors 310. The memory 312 can be a type of transitory or non-transitory computer readable medium capable of storing information accessible by the processors 310, such as volatile and non-volatile memory. The processors 310 can include one or more central processing units (CPUs), graphic processing units (GPUs), field-programmable gate arrays (FPGAs), and/or application-specific integrated circuits (ASICs), such as tensor processing units (TPUs).

The instructions 314 can include one or more instructions that, when executed by the processors 310, cause the one or more processors 310 to perform actions defined by the instructions 314. The instructions 314 can be stored in object code format for direct processing by the processors 310, or in other formats including interpretable scripts or collections of independent source code modules that are interpreted on demand or compiled in advance. The instructions 314 can include instructions for implementing a USP system 318, which can correspond to the USP system 100 of FIG. 1 or the USP system 200 of FIG. 2. The USP system 318 can be executed using the processors 310, and/or using other processors remotely located from the server computing device 302.

The data 316 can be retrieved, stored, or modified by the processors 310 in accordance with the instructions 314. The data 316 can be stored in computer registers, in a relational or non-relational database as a table having a plurality of different fields and records, or as JSON, YAML, proto, or XML documents. The data 316 can also be formatted in a computer-readable format such as, but not limited to, binary values, ASCII, or Unicode. Moreover, the data 316 can include information sufficient to identify relevant information, such as numbers, descriptive text, proprietary codes, pointers, references to data stored in other memories, including other network locations, or information that is used by a function to calculate relevant data.

The client computing device 304 can also be configured similarly to the server computing device 302, with one or more processors 320, memory 322, instructions 324, and data 326. The client computing device 304 can also include a user input 328 and a user output 330. The user input 328 can include any appropriate mechanism or technique for receiving input from a user, such as keyboard, mouse, mechanical actuators, soft actuators, touchscreens, microphones, and sensors.

The server computing device 302 can be configured to transmit data to the client computing device 304, and the client computing device 304 can be configured to display at least a portion of the received data on a display implemented as part of the user output 330. The user output 330 can also be used for displaying an interface between the client computing device 304 and the server computing device 302. The user output 330 can alternatively or additionally include one or more speakers, transducers or other audio outputs, a haptic interface or other tactile feedback that provides non-visual and non-audible information to the platform user of the client computing device 304.

Although FIG. 3 illustrates the processors 310, 320 and the memories 312, 322 as being within the respective computing devices 302, 304, components described herein can include multiple processors and memories that can operate in different physical locations and not within the same computing device. For example, some of the instructions 314, 324 and the data 316, 326 can be stored on a removable SD card and others within a read-only computer chip. Some or all of the instructions 314, 324 and data 316, 326 can be stored in a location physically remote from, yet still accessible by, the processors 310, 320. Similarly, the processors 310, 320 can include a collection of processors that can perform concurrent and/or sequential operation. The computing devices 302, 304 can each include one or more internal clocks providing timing information, which can be used for time measurement for operations and programs run by the computing devices 302, 304.

The server computing device 302 can be connected over the network 308 to a data center 332 housing any number of hardware accelerators 334. The data center 332 can be one of multiple data centers or other facilities in which various types of computing devices, such as hardware accelerators, are located. Computing resources housed in the data center 332 can be specified for deploying models, such as for classification, short form generation, and/or long form generation, as described herein.

The server computing device 302 can be configured to receive requests to process data from the client computing device 304 on computing resources in the data center 332. For example, the environment 300 can be part of a computing platform configured to provide a variety of services to users, through various user interfaces and/or application programming interfaces (APIs) exposing the platform services. The variety of services can include classification tasks, short form generation tasks, and/or long form generation tasks, as described herein. The client computing device 304 can transmit input data as part of a query for a particular task. The USP system 318 can receive the input data, and in response, generate output data including a response to the query for the particular task.

As other examples of potential services provided by a platform implementing the environment, the server computing device 302 can maintain a variety of models in accordance with different constraints available at the data center 332. For example, the server computing device 302 can maintain different families for deploying models on various types of TPUs and/or GPUs housed in the data center 332 or otherwise available for processing.

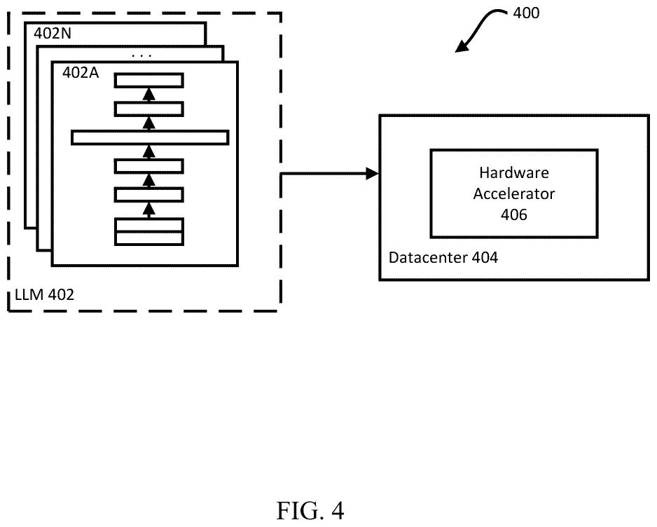

FIG. 4 depicts a block diagram 400 illustrating one or more machine learning model architectures 402, more specifically 402A-N for each architecture, for deployment in a datacenter 404 housing a hardware accelerator 406 on which the deployed machine learning models 402 will execute, such as for the variety of services as described herein. The hardware accelerator 406 can be any type of processor, such as a CPU, GPU, FPGA, or ASIC such as a TPU.

An architecture 402 of a machine learning model can refer to characteristics defining the model, such as characteristics of layers for the model, how the layers process input, or how the layers interact with one another. The architecture 402 of the machine learning model can also define types of operations performed within each layer. One or more machine learning model architectures 402 can be generated that can output results, such as for classification, short form generation, and/or long form generation. Example model architectures 402 can correspond to a large language model or an encoder/decoder model.

Referring back to FIG. 3, the devices 302, 304 and the data center 332 can be capable of direct and indirect communication over the network 308. For example, using a network socket, the client computing device 304 can connect to a service operating in the data center 332 through an Internet protocol. The devices 302, 304 can set up listening sockets that may accept an initiating connection for sending and receiving information. The network 308 can include various configurations and protocols including the Internet, World Wide Web, intranets, virtual private networks, wide area networks, local networks, and private networks using communication protocols proprietary to one or more companies. The network 308 can support a variety of short- and long-range connections. The short- and long-range connections may be made over different bandwidths, such as 2.402 GHz to 2.480 GHz, commonly associated with the Bluetooth® standard, 2.4 GHz and 5 GHZ, commonly associated with the Wi-Fi® communication protocol; or with a variety of communication standards, such as the LTE® standard for wireless broadband communication. The network 308, in addition or alternatively, can also support wired connections between the devices 302, 304 and the data center 332, including over various types of Ethernet connection.

Although a single server computing device 302, client computing device 304, and data center 332 are shown in FIG. 3, it is understood that the aspects of the disclosure can be implemented according to a variety of different configurations and quantities of computing devices, including in paradigms for sequential or parallel processing, or over a distributed network of multiple devices. In some implementations, aspects of the disclosure can be performed on a single device connected to hardware accelerators configured for processing optimization models, and any combination thereof.

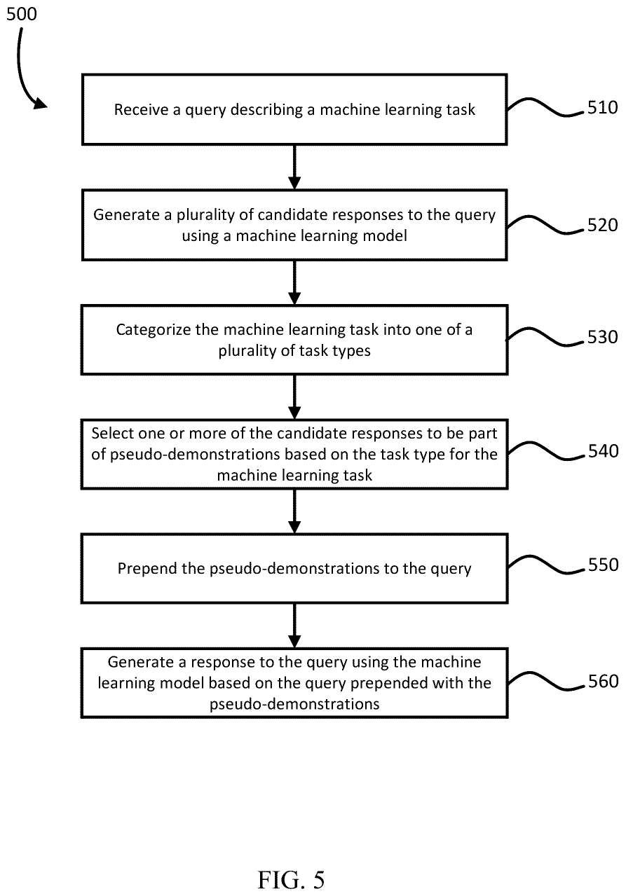

FIG. 5 depicts a flow diagram of an example process 500 for universal self-adaptive prompting. The example process 500 can be performed on a system of one or more processors in one or more locations, such as the USP system 100 as depicted in FIG. 1.

As shown in block 510, the USP system 100 can be configured to receive a query describing a machine learning task. The query can include an unlabeled dataset for responding to the machine learning task. Example machine learning tasks can include natural language processing tasks like classification, reading comprehension, cloze completion, and/or natural language inference, short form generation tasks like open domain question-answer and/or word prediction, and/or long form generation tasks like summarization and/or translation.

As shown in block 520, the USP system 100 can be configured to generate a plurality of candidate responses to the query using a machine learning model. The machine learning model can be a large language model, as an example. The USP system 100 can be configured to generate the plurality of candidate responses in a zero shot manner using the unlabeled dataset of the query.

As shown in block 530, the USP system 100 can be configured to categorize the machine learning task into one of a plurality of task types. The plurality of task types can include classification, short form generation, and/or long form generation, as examples. Categorizing the machine learning task can be based on an amount of possible responses and an amount of correct responses. For example, the machine learning task can be categorized as classification if the amount of possible responses is below a threshold and the amount of correct responses is also below a threshold. As another example, the machine learning task can be categorized as short form generation if the amount of possible responses is above a threshold and the amount of correct responses is above a threshold. As yet another example, the machine learning task can be categorized as long form generation if the amount of possible responses is above a threshold and the amount of correct responses is also above a threshold.

As shown in block 540, the USP system 100 can be configured to select one or more candidate responses of the plurality of candidate responses to be part of one or more pseudo-demonstrations based on the task type the machine learning task was categorized as. The USP system can select suitable query-response pairs to be the pseudo-demonstrations. For example, the USP system 100 can select candidate responses based on an entropy metric for classification task types, a consistency metric for short form generation task types, and/or an overlap metric for long form generation task types. The USP system 100 can select candidate responses that are above an entropy metric threshold for classification, above a consistency metric threshold for short form generation, and/or above an overlap metric threshold for long form generation.

As shown in block 550, the USP system 100 can prepend the one or more pseudo-demonstrations to the query. For example, the USP system 100 can concatenate the pseudo-demonstrations as labels for unlabeled data of the unlabeled dataset for responding to the machine learning task.

As shown in block 560, the USP system 100 can generate a response to the query using the machine learning model based on the query prepended with the one or more pseudo-demonstrations. The USP system 100 can be configured to generate the response in a few shot manner using unlabeled dataset prepended with the pseudo-demonstrations. The response to the query can be generated based on a maximum likelihood estimated output. Alternatively, or additionally, the USP system 100 can generate a plurality of responses to the query using the machine learning model based on the query prepended with the one or more pseudo-demonstrations. A final response to the query can then be selected based on a majority voting output, or a threshold plurality output, of the plurality of responses.

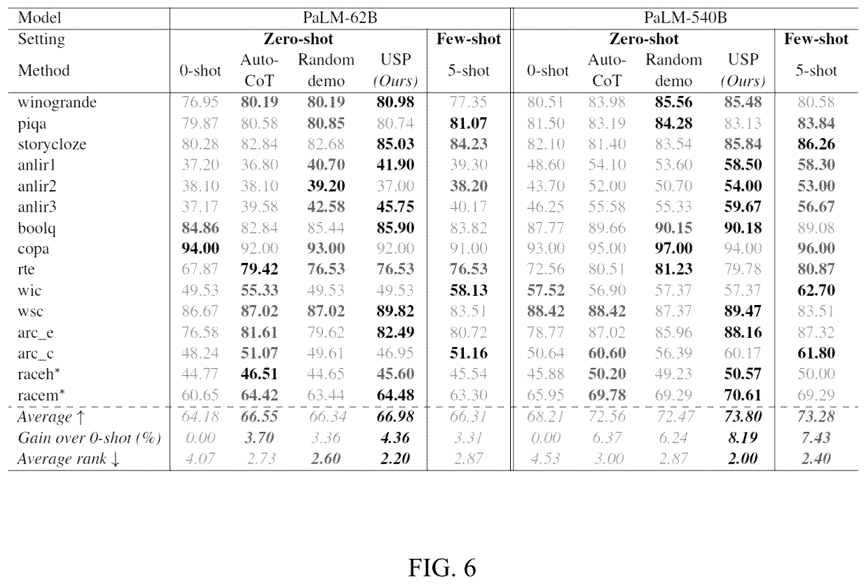

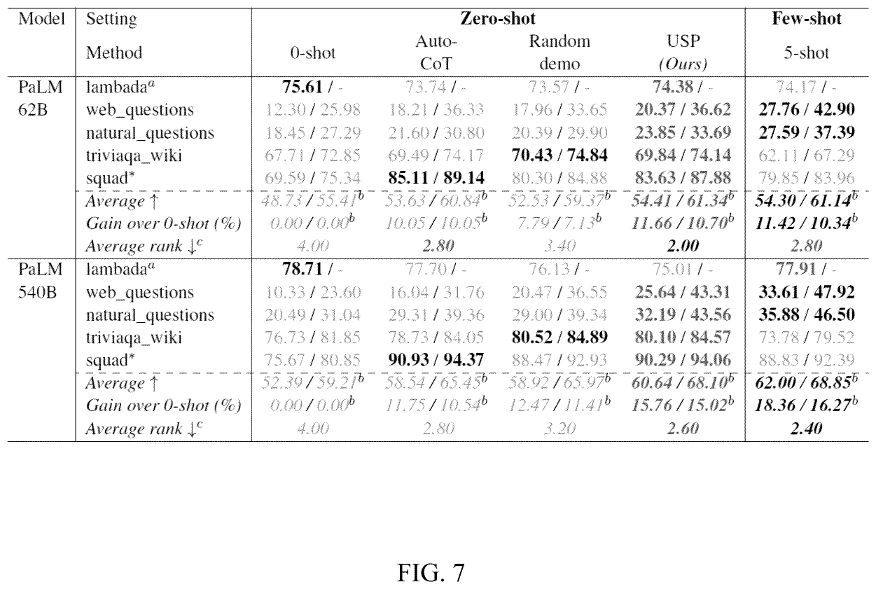

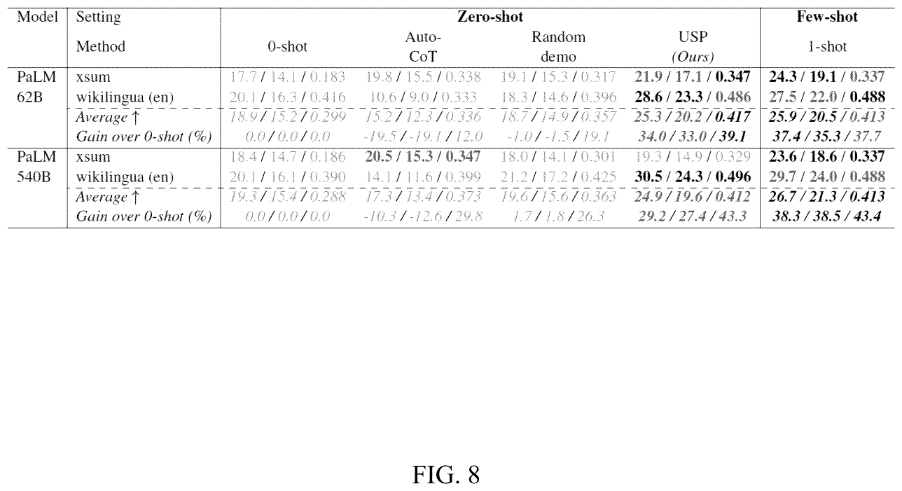

As illustrated in FIGS. 6-8, a USP system can achieve or improve upon alternative approaches for various machine learning tasks with a dataset of 64 unlabeled samples per task. PaLM-540B and PaLM-62B pathway language models were utilized on a wide variety of common natural language processing tasks to show the USP system is an improvement in computer technology. Classification tasks include commonsense reasoning, such as boolq, winogrande, ARC easy and challenge, wsc, reading comprehension, such as raceh, racem, cloze completion, such as storycloze, and natural language inference, such as anli-r, rte, and wic. Short form generation tasks include open domain QA, such as web_questions, natural_questions, and triviaqa_wiki, and word prediction, such as lambada. Long form generation tasks include summarization, such as xsum and wikilingua. USP is compared against four alternatives, including 0-shot prompting, an auto-chain-of-thought, a random demonstration, and a 5-shot prompting. FIG. 6 depicts a table comparing accuracy on classification tasks using the pathway language models. FIG. 7 depicts a table comparing performance on short form generation tasks using the pathway language models. FIG. 8 depicts a table comparing performance on long form generation tasks using the pathway language models. The tables illustrate that the USP system generally outperforms the other approaches and given the small dataset, can reduce computational complexity and memory usage as well.

Aspects of this disclosure can be implemented in digital electronic circuitry, in tangibly embodied computer software or firmware, and/or in computer hardware, such as the structure disclosed herein, their structural equivalents, or combinations thereof. Aspects of this disclosure can further be implemented as one or more computer programs, such as one or more modules of computer program instructions encoded on a tangible non-transitory computer storage medium for execution by, or to control the operation of, one or more data processing apparatus. The computer storage medium can be a machine-readable storage device, a machine-readable storage substrate, a random or serial access memory device, or combinations thereof. The computer program instructions can be encoded on an artificially generated propagated signal, such as a machine-generated electrical, optical, or electromagnetic signal, that is generated to encode information for transmission to suitable receiver apparatus for execution by a data processing apparatus.

The term “configured” is used herein in connection with systems and computer program components. For a system of one or more computers to be configured to perform particular operations or actions means that the system has installed thereon software, firmware, hardware, or a combination thereof that cause the system to perform the operations or actions. For one or more computer programs to be configured to perform particular operations or actions means that the one or more programs include instructions that, when executed by one or more data processing apparatus, cause the apparatus to perform the operations or actions.

The term “data processing apparatus” or “data processing system” refers to data processing hardware and encompasses various apparatus, devices, and machines for processing data, including programmable processors, computers, or combinations thereof. The data processing apparatus can include special purpose logic circuitry, such as a field programmable gate array (FPGA) or an application specific integrated circuit (ASIC). The data processing apparatus can include code that creates an execution environment for computer programs, such as code that constitutes processor firmware, a protocol stack, a database management system, an operating system, or combinations thereof.

The term “computer program” refers to a program, software, a software application, an app, a module, a software module, a script, or code. The computer program can be written in any form of programming language, including compiled, interpreted, declarative, or procedural languages, or combinations thereof. The computer program can be deployed in any form, including as a standalone program or as a module, component, subroutine, or other unit suitable for use in a computing environment. The computer program can correspond to a file in a file system and can be stored in a portion of a file that holds other programs or data, such as one or more scripts stored in a markup language document, in a single file dedicated to the program in question, or in multiple coordinated files, such as files that store one or more modules, sub programs, or portions of code. The computer program can be executed on one computer or on multiple computers that are located at one site or distributed across multiple sites and interconnected by a data communication network.

The term “database” refers to any collection of data. The data can be unstructured or structured in any manner. The data can be stored on one or more storage devices in one or more locations. For example, an index database can include multiple collections of data, each of which may be organized and accessed differently.

The term “engine” refers to a software-based system, subsystem, or process that is programmed to perform one or more specific functions. The engine can be implemented as one or more software modules or components or can be installed on one or more computers in one or more locations. A particular engine can have one or more computers dedicated thereto, or multiple engines can be installed and running on the same computer or computers.

The processes and logic flows described herein can be performed by one or more computers executing one or more computer programs to perform functions by operating on input data and generating output data. The processes and logic flows can also be performed by special purpose logic circuitry, or by a combination of special purpose logic circuitry and one or more computers.

A computer or special purpose logic circuitry executing the one or more computer programs can include a central processing unit, including general or special purpose microprocessors, for performing or executing instructions and one or more memory devices for storing the instructions and data. The central processing unit can receive instructions and data from the one or more memory devices, such as read only memory, random access memory, or combinations thereof, and can perform or execute the instructions. The computer or special purpose logic circuitry can also include, or be operatively coupled to, one or more storage devices for storing data, such as magnetic, magneto optical disks, or optical disks, for receiving data from or transferring data to. The computer or special purpose logic circuitry can be embedded in another device, such as a mobile phone, a personal digital assistant (PDA), a mobile audio or video player, a game console, a Global Positioning System (GPS), or a portable storage device, e.g., a universal serial bus (USB) flash drive, as examples.

Computer readable media suitable for storing the one or more computer programs can include any form of volatile or non-volatile memory, media, or memory devices. Examples include semiconductor memory devices, e.g., EPROM, EEPROM, or flash memory devices, magnetic disks, e.g., internal hard disks or removable disks, magneto optical disks, CD-ROM disks, DVD-ROM disks, or combinations thereof.

Aspects of the disclosure can be implemented in a computing system that includes a back end component, e.g., as a data server, a middleware component, e.g., an application server, or a front end component, e.g., a client computer having a graphical user interface, a web browser, or an app, or any combination thereof. The components of the system can be interconnected by any form or medium of digital data communication, such as a communication network. Examples of communication networks include a local area network (LAN) and a wide area network (WAN), e.g., the Internet.

The computing system can include clients and servers. A client and server can be remote from each other and interact through a communication network. The relationship of client and server arises by virtue of the computer programs running on the respective computers and having a client-server relationship to each other. For example, a server can transmit data, e.g., an HTML page, to a client device, e.g., for purposes of displaying data to and receiving user input from a user interacting with the client device. Data generated at the client device, e.g., a result of the user interaction, can be received at the server from the client device.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A method for universal self-adaptive prompting, comprising:
receiving, by one or more processors, a query describing a machine learning task;
generating, by the one or more processors, a plurality of candidate responses to the query using a machine learning model;
categorizing, by the one or more processors, the machine learning task into one of a plurality of task types;
selecting, by the one or more processors, one or more candidate responses of the plurality of candidate responses to be pseudo-demonstrations based on the task type for the machine learning task;
prepending, by the one or more processors, the pseudo-demonstrations to the query; and
generating, by the one or more processors, a response to the query using the machine learning model based on the query prepended with the pseudo-demonstrations.

2. The method of claim 1, wherein the plurality of task types comprises classification, short form generation, and long form generation.

3. The method of claim 2, wherein selecting the one or more candidate responses is based on an entropy metric for classification task types, a consistency metric for short form generation task types, and an overlap metric for long form generation task types.

4. The method of claim 1, wherein the query received comprises an unlabeled dataset.

5. The method of claim 1, wherein categorizing the machine learning task is based on an amount of possible responses and an amount of correct responses.

6. The method of claim 1, wherein the response to the query is generated based on a maximum likelihood estimated output.

7. The method of claim 1, wherein generating the response to the query is repeated a plurality of times using the machine learning model based on the query prepended with the pseudo-demonstrations.

8. The method of claim 7, further comprises generating a final response to the query based on a majority voting output.

9. The method of claim 1, wherein the machine learning model is a large language model.

10. A system comprising:
one or more processors; and
one or more storage devices coupled to the one or more processors and storing instructions that, when executed by the one or more processors, cause the one or more processors to perform operations for universal self-adaptive prompting, the operations comprising:
receiving a query describing a machine learning task;
generating a plurality of candidate responses to the query using a machine learning model;
categorizing the machine learning task into one of a plurality of task types;
selecting one or more candidate responses of the plurality of candidate responses to be pseudo-demonstrations based on the task type for the machine learning task;
prepending the pseudo-demonstrations to the query; and
generating a response to the query using the machine learning model based on the query prepended with the pseudo-demonstrations.

11. The system of claim 10, wherein the plurality of task types comprises classification, short form generation, and long form generation.

12. The system of claim 11, wherein selecting the one or more candidate responses is based on an entropy metric for classification task types, a consistency metric for short form generation task types, and an overlap metric for long form generation task types.

13. The system of claim 10, wherein the query received comprises an unlabeled dataset.

14. The system of claim 10, wherein categorizing the machine learning task is based on an amount of possible responses and an amount of correct responses.

15. The system of claim 10, wherein the response to the query is generated based on a maximum likelihood estimated output.

16. The system of claim 10, wherein generating the response to the query is repeated a plurality of times using the machine learning model based on the query prepended with the pseudo-demonstrations.

17. The system of claim 16, wherein the operations further comprise generating a final response to the query based on a majority voting output.

18. A non-transitory computer readable medium for storing instructions that, when executed by one or more processors, cause the one or more processors to perform operations for universal self-adaptive prompting, the operations comprising:
receiving a query describing a machine learning task;
generating a plurality of candidate responses to the query using a machine learning model;
categorizing the machine learning task into one of a plurality of task types;
selecting one or more candidate responses of the plurality of candidate responses to be pseudo-demonstrations based on the task type for the machine learning task;
prepending the pseudo-demonstrations to the query; and
generating a response to the query using the machine learning model based on the query prepended with the pseudo-demonstrations.

19. The non-transitory computer readable medium of claim 18, wherein the plurality of task types comprises classification, short form generation, and long form generation.

20. The non-transitory computer readable medium of claim 19, wherein selecting the one or more candidate responses is based on an entropy metric for classification task types, a consistency metric for short form generation task types, and an overlap metric for long form generation task types.
